(19) United States
(12) Patent Application Publication
(10) Pub. No.: US 2017/0102403 A1
(43) Pub. Date: Apr. 13, 2017

(54) ACTUATION DEVICE FOR A PISTON OF A SYRINGE

(71) Applicant: CTC Analytics AG, Zwingen (CH)

(72) Inventors: Melchior ZUMBACH, Lenzburg (CH); Roland KERNEN, Muttenz (CH)

(73) Assignee: CTC Analytics AG, Zwingen (CH)

(21) Appl. No.: 15/271,391

(22) Filed: Sep. 21, 2016

(30) Foreign Application Priority Data
Oct. 9, 2015 (EP) 15 189 183.5

(51) Int. Cl. G01N 35/10; F04B 53/14; F04B 19/22; F04B 53/16; G01N 1/14; F04B 9/00

(52) U.S. Cl. CPC G01N 35/1009; G01N 1/14; F04B 9/00; F04B 19/22; F04B 53/16; F04B 53/14; G01N 2001/1427

(57) ABSTRACT

The present application relates to an actuation device for a piston of a syringe. The actuation device comprises a holder for a barrel of the syringe, a coupling which is linearly movable relative to the holder and has a seat into which the piston of the syringe can be inserted, at least one securing element with which the piston can be secured releasably in the seat, and a linear drive for the coupling. The coupling has at least two electrically conductive contact elements which are arranged inside the seat in order to come into contact with corresponding electrically conductive contact faces of the piston when the piston is inserted into the seat. The present application further relates to a sampling system with an actuation device and with at least one syringe, and also to a syringe suitable for the sampling system.

### TECHNICAL FIELD

The invention relates to an actuation device for a piston of a syringe, in which electrical signals can be transmitted between the syringe and the actuation device by means of contact elements with contact faces located on the piston of the syringe. The invention moreover relates to a sampling system with an actuation device and with at least one syringe, and also to a syringe suitable for this sampling system.

### PRIOR ART

Actuation devices, for pistons of syringes, and sampling systems have already been known for some time in the field of laboratory equipment. Such devices and systems are in particular used in the course of laboratory automation such that a large number of samples can be prepared with a high degree of precision, for example for subsequent chromatographic analysis. In such pipetting procedures, it is desirable for the automatic systems and devices to contain data relating to the syringe used, so as to avoid any errors that may arise through the use of syringes that are unsuitable or too old. Moreover, in the process of documentation, in particular in the medical sector, it is advantageous if, for example, it can be established without any doubt which sample has been prepared with which syringe. Therefore, some systems and devices are known in the prior art in which information is exchanged between an actuation device or a sampling system and a memory located on the syringe.

### DISCLOSURE OF THE INVENTION

The object of the invention is to make available an actuation device for a piston of a syringe, which actuation device belongs to the technical field mentioned at the outset and, in the simplest possible way, allows data exchange with a memory element arranged on the syringe.

The object is achieved by the features of claim 1. According to the invention, the actuation device has a holder for a barrel of the syringe. Moreover, the actuation device comprises a coupling which is linearly movable relative to the holder and has a seat into which the piston of the syringe can be inserted, at least one securing element with which the piston can be secured releasably in the seat, and a linear drive for the coupling. The coupling has at least two electrically conductive contact elements which are arranged on an inner wall of the seat in order to come into contact with corresponding electrically conductive contact faces of the piston when the piston is inserted into the seat.

The at least one securing element of the coupling provides a fixed mechanical connection between piston and coupling, as a result of which a reliable contact between the electrically conductive contact elements and the contact faces of the piston is permitted. Data exchange between a memory element, arranged on the piston of the syringe, and the actuation device can be achieved without expensive electronic components such as transmitters or receivers for wireless data transfer, and therefore the manufacturing costs both of the actuation device and also of the piston can be kept down. Moreover, by means of the electrical contact, a memory element arranged on the piston can be supplied with current, and therefore no additional source of current has to be arranged in or on the piston.

The holder preferably has a securing device with which the barrel of the syringe can be secured releasably thereto. The securing device is preferably designed in such a way that the barrel of the syringe is held with form-fit engagement in the holder. The holder is preferably connected releasably to the securing device. In order to use another syringe with the actuation device, in this case the holder is replaced by a holder with the required syringe. For the releasable connection of the holder to the actuation device, these have corresponding holding means which are in particular designed in such a way that an automatic exchange of the holder, and therefore of the syringe placed in the holder, can take place. A holder of this kind is described, for example, in EP 2 261 676 B1 from the applicant. In this way, the actuation device according to the invention can be used in a pipetting robot with automatic syringe exchange.

The inner wall of the seat is preferably designed in such a way that it defines an interior which substantially corresponds to the outer shape of an end area of the piston, such that the piston can be held inside the seat with the least possible play.

The at least one securing element is preferably designed in such a way that it releasably secures the piston with force-fit and/or form-fit engagement in the seat.

The coupling can be moved linearly relative to the holder by means of the linear drive. Since the barrel of the syringe is secured in the holder and the piston is secured in the coupling, this relative movement between holder and coupling leads to a linear movement of the piston inside the barrel. In this way, liquids can be drawn into or ejected from the syringe.

A ram is preferably arranged inside the seat, with which ram a piston located in the seat can be pushed out when released. In particular, this ram is preferably prestressed by a spring element in the direction of an opening through which the piston can be inserted into the seat. Moreover, with this prestressing, a force is exerted permanently on a piston located in the seat, as a result of which it is possible to reduce any play in the axial direction between piston and securing element. This permits more precise guiding of the piston by the coupling.

It is particularly preferable that the at least two electrically conductive contact elements are arranged on a side of the ram that comes into contact with the piston when the piston is inserted into the seat. The prestressing of the ram has the effect that the at least two contact elements are pressed against the piston, which greatly improves the mechanical contact of the electrically conductive contact elements with the piston. Alternatively, it is also possible for just one of the at least two electrically conductive contact elements to be arranged on the ram. In this case, the inner wall of the seat can form the second contact element or can have at least one further contact element.

Moreover, provision can also be made that the ram is formed as a first of the at least two contact elements. In this embodiment, the ram has to be produced from an electrically conductive material.

In the context of the present application, “axial direction” is understood as the direction in which the longitudinal axis of the syringe and of the piston lies when the syringe is secured on the actuation device. The linear displacement of the coupling relative to the holder takes place along this axial direction.

It is particularly preferable that the actuation device is arranged on an arm of a sampling system mounted displaceably in at least one spatial axis. The sampling system is in particular designed as a pipetting robot which automatic processing of liquid samples, for example for automated chromatography procedures, in particular liquid chromatography, mass spectrometry or gas chromatography.

The inner wall of the coupling is preferably designed as a first contact element of the at least two contact elements. For this purpose, the inner wall of the seat is made from a conductive material, for example copper or steel. The at least one further electrically conductive contact element is electrically insulated from the inner wall of the seat in this configuration. It is particularly preferable in this embodiment that the inner wall carries the reference potential and accordingly serves as mass for a memory element arranged on the syringe.

Preferably, a first contact element of the at least two contact elements is designed as a round face, and the at least one further contact element is designed as a circle concentric to the round face.

In this way, it is at all times possible to guarantee that the contact faces located on the piston of the syringe are touched by the contact elements without the piston having to adopt a specific position with respect to the rotation about its longitudinal axis. For example, it is thus possible, independently of the rotation position of the piston, to produce an electrical contact between contact faces, formed on the latter as pins, and the contact elements. This simplifies the handling of the actuation device.

Preferably, the at least two contact elements are prestressed inside the seat, counter to a direction of insertion of the piston, by a spring element. Preferably, the prestressing of the at least two contact elements is effected via a common spring element. Particularly preferably, a separate spring element is provided for each of the at least two contact elements. It is thus possible to ensure that the contact elements are at all times pressed onto the contact faces of a syringe secured in the seat, independently of any manufacturing tolerances.

The at least one securing element is preferably designed as a form-fit element, which can engage in a circumferential groove of the piston when the piston is inserted into the seat.

The form-fit element preferably comprises at least one ball which is placed in an opening of the seat, wherein a sleeve is arranged on the outside of the seat and is movable relative to the seat from a first position to a second position such that, in the first position, the at least one ball is pressed by the sleeve into an interior of the seat and, in the second position, the at least one ball is movable out of the interior.

This results in a securing element that has a very simple design and is easy to operate. The ball preferably engages in a groove surrounding the piston, in order to secure the piston in the seat with form-fit engagement. In this way, the piston can at all times be secured in the seat, without the piston first having to be rotated to the correct position.

It is particularly preferable that the form-fit element comprises three balls which are preferably arranged at an angle of 120° relative to each other about the axial direction. In this way, the form-fit element has the effect that the piston is centred on the axial direction.

The sleeve is preferably prestressed into the first position by a first spring element. The actuation device preferably has an actuator with which the sleeve can be moved automatically from the first position to the second position and back again. In this way, a piston can be secured in the seat and released from the seat without the intervention of operating personnel, as a result of which the actuation device can be used in an automated pipetting robot.

The opening, the ball and the sleeve are preferably designed in such a way that the ball cannot fall out of the coupling.

The linear drive preferably comprises at least one spindle. The use of a spindle permits very precise movement of the coupling, and therefore of a syringe piston secured in the seat, and, when the actuation device is used in a pipetting robot, this allows precisely defined amounts of a liquid to be taken up or dispensed by the syringe.

The at least one securing element is preferably designed in such a way that the piston can be automatically secured in the seat and released therefrom.

The present application further relates to a sampling system with an actuation device according to the invention and with at least one syringe. The syringe has a barrel and a piston arranged partially inside the barrel and linearly displaceable therein, wherein a non-volatile memory element is arranged on an end of the piston not arranged inside the barrel. The memory element is connected to at least two electrically conductive contact faces, which are shaped and arranged on the barrel in such a way that they can come into contact with the electrically conductive contact elements of the actuation device when the piston is inserted into the seat.

The actuation device is preferably connected to an electronic control system or comprises an electronic control system, wherein the electronic control system is for this purpose configured to read out data from the non-volatile memory element and/or to write data into the latter.

In this way, data can be retrieved from the memory element prior to a sampling procedure, and, after a sampling procedure has been carried out, data can be written onto the memory element or data can be changed. In a fully automatic system in particular, it is thus possible, for example, to check whether a syringe with the correct volume is connected to the actuation device. Moreover, data relating to the use of the syringe can be stored on the memory element.

The electronic control system is preferably configured in such a way that it permits automatic securing and release of the syringe. That is to say, the electronic control system can control motors with which the actuation device can be moved in at least one spatial direction. Moreover, the linear drive of the actuation device is also preferably connected to the electronic control system and can be controlled by the latter.

Moreover, the electronic control system is also configured in such a way that it can be connected via a connection to a network in order to permit complete integration of the sampling system in a production or analysis set-up and/or to permit data exchange with further electronic appliances.

The data preferably contain at least one of the following items of information: number of piston strokes executed, size of the barrel, serial number of the syringe, production date of the syringe, total travel of the executed piston strokes, manufacturer of the syringe, data of the first executed piston stroke, size of the needle connected to the barrel.

On the basis of these data, the electronic control system can be used to check whether the syringe secured on the actuation device is suitable for the intended sampling. On the one hand, the transmitted data relating to the syringe can be compared directly with the required properties for the planned sampling procedure. On the other hand, the suitability of the syringe for the planned sampling procedure can also be checked on the basis, for example, of a serial number or batch number by comparison with a database that is either stored in a memory of the electronic control system or can be interrogated on a remote server via a network.

The form-fit element preferably comprises at least one ball which is placed in an opening of the seat, wherein a sleeve is arranged on the outside of the seat and is movable relative to the seat from a first position to a second position such that, in the first position, the at least one ball is pressed by the sleeve into an interior of the seat and, in the second position, the at least one ball is movable out of the interior. An outer circumferential surface of the piston of the syringe has a circumferential groove in which the ball engages when the sleeve is in the first position.

A configuration of this kind allows the piston to be secured in the seat in a way that is as simple as possible in mechanical terms, and yet efficient. Since the ball can be brought into engagement with the groove about the entire circumference of the piston, the piston does not also have to be specifically oriented in order to permit securing, and this greatly simplifies handling.

Particularly preferably, the form-fit element comprises three balls which are placed in corresponding openings of the seat. The balls are in particular arranged at an angle of 120° relative to each other on the circumference of the seat. This allows the piston to be centred.

The following application further relates to a syringe for a sampling system according to the invention. The syringe comprises a barrel and a piston arranged partially inside the barrel and linearly displaceable therein, wherein a non-volatile memory element is arranged on an end of the piston not arranged inside the barrel, which memory element is connected to at least two electrically conductive contact faces.

The electrically conductive contact faces are located on the surface of the piston such that they can come into contact with the corresponding contact elements of the seat when the piston is placed in the seat of the actuation device.

The memory element is preferably let into the material of the piston and is connected to the contact faces by electrical leads. For example, the memory element, and lines leading to it and connected to the contact faces, can be encapsulated by injection moulding during the production of the piston. In this production method, it is necessary to ensure that the memory element used does not suffer damage at the temperatures during the injection moulding.

A first contact face of the at least two contact faces is preferably round, and the at least one further contact face is preferably designed as a circle concentric to the round contact face.

In this way, it is at all times possible to guarantee that the contact elements inside the seat of the actuation device are contacted without the piston having to adopt a specific position with respect to the rotation about its longitudinal axis.

In the arrangement with more than two contact faces, these contact faces, with the exception of the first round contact face, are designed as circles that are spaced apart from each other and that are concentric relative to each other.

The at least two contact faces are arranged on a base surface of the piston lying at right angles to the axial direction.

Alternatively, a first contact face can be designed as a printed circuit board which is arranged on the circumferential surface of the piston and which is in contact with the inner wall of the seat when the piston is placed in the seat.

Further advantageous embodiments and combinations of features of the invention will become clear from the following detailed description and from all of the patent claims.

### BRIEF DESCRIPTION OF THE DRAWINGS

In the drawings used to explain the illustrative embodiment:

FIG. 1 shows a schematic view of a sampling system according to the invention;

FIG. 2 shows a sectional view of the sampling system from FIG. 1;

FIG. 3 shows a sectional view of the sampling system from FIG. 2, with the syringe released from the actuation device;

FIG. 4 shows a more detailed view of a chip arrangement with contact faces and memory element.

In principle, identical parts are provided with identical reference signs in the figures.

### WAYS OF IMPLEMENTING THE INVENTION

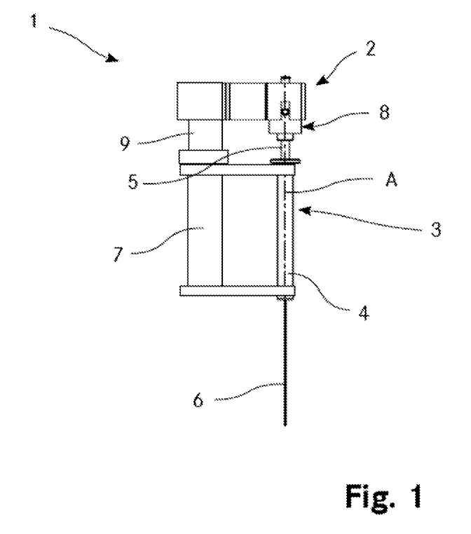

FIG. 1 shows a schematic view of a sampling system 1 according to the invention with an actuation device 2 to which a syringe 3 is secured. The syringe 3 has a barrel 4 in which a piston 5 is mounted in a linearly displaceable manner. Moreover, a needle 6 is connected to the barrel 4 of the syringe 3, via which needle 6 a liquid can be drawn in or ejected.

The actuation device 2 has a holder 7 for the barrel 4 of the syringe 3, and a coupling 8 to which the piston 5 of the syringe 3 is releasably connected. The coupling 8 is linearly displaceable relative to the holder 7 by a linear drive 9. This displacement has the effect that the piston 5 is also displaced inside the barrel 4. The displacement path of the piston 5 inside the barrel 4 of the syringe 3 takes place in the axial direction. The axial direction is parallel to the longitudinal axis A of the syringe 3.

The holder 7 is connected releasably to the actuation device 1 by holding means, such that the holder 7 can be removed and exchanged along with the syringe 3 secured to it. Thus, the syringe 3 used with the actuation device 1 can be exchanged very quickly and easily, since a new syringe 3 does not have to be secured on the holder 4, and instead only the holder 4, which can be connected to the actuation device 1 by holding means, is exchanged. Thus, when exchanging the syringe 3, there is no need for the time-consuming clamping, particularly when exchanging with a syringe 3 having a greater or smaller barrel.

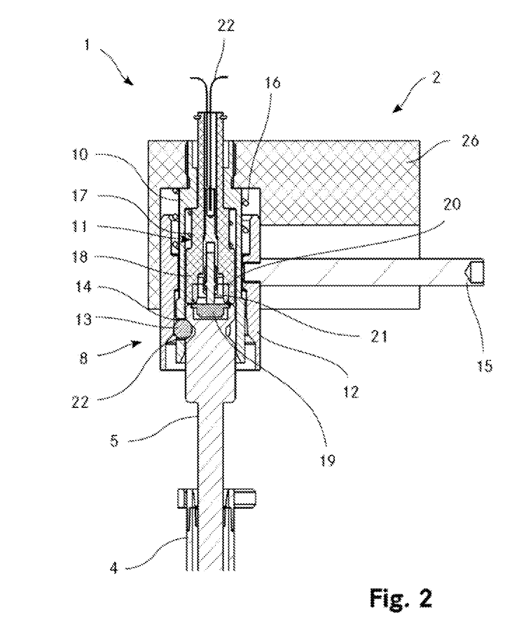

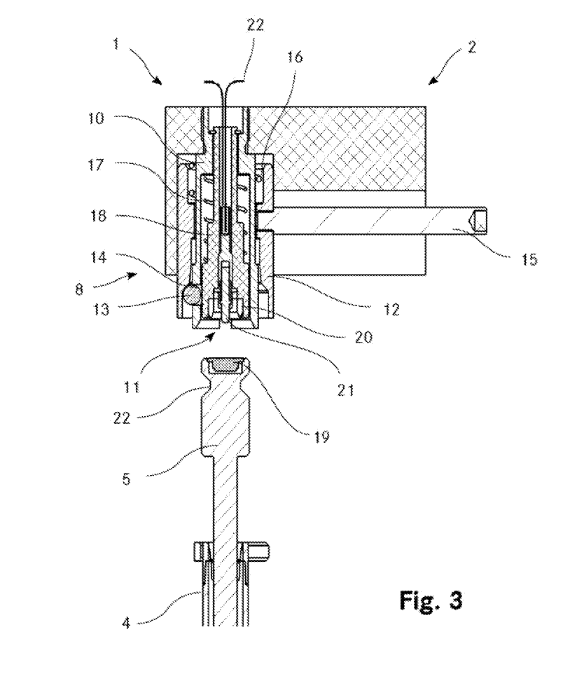

FIGS. 2 and 3 show sectional views of the sampling system from FIG. 1. FIG. 2 shows the situation according to FIG. 1, in which the syringe 3 is secured on the actuation device 2. FIG. 3 shows the situation when the syringe is released from the actuation device 2.

The coupling 8 has a seat 11 into which an end of the piston 5 of the syringe 3 is insertable. The seat 11 has a circumferential wall 10, which is secured on an arm 26. The arm 26 connects the coupling 8 to the linear drive 9, with which the coupling can be linearly displaced relative to the holder 7.

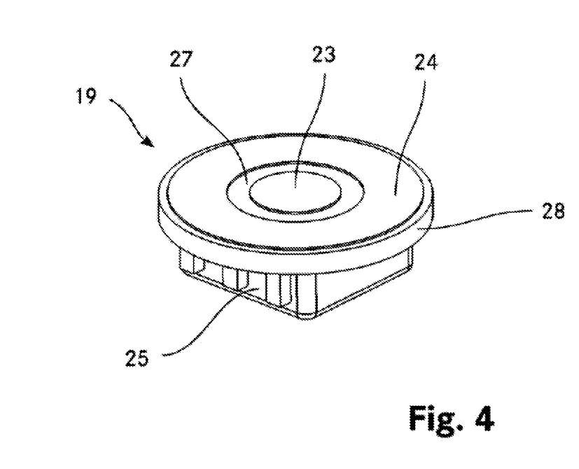

The piston 5 has a chip arrangement 19, which is shown in somewhat greater detail in FIG. 4. The chip arrangement 19 has at least two contact faces (see FIG. 4) which are in contact with two contact elements 20, 21 which are arranged inside the seat 11 of the coupling 8 when the piston 5 is inserted in the seat 11. The contact elements 20, 21 are connected via cable 22 to an electronic control system (not shown). When the contact faces of the chip arrangement 19 are in contact with the contact elements 20, 21, electrical signals can be exchanged between the chip arrangement 19 and the electronic control system, in particular in order to write data in a memory element of the chip arrangement 19 or to read out data therefrom.

The coupling 8 moreover has a sleeve 12 which is arranged on the outside of the wall 10 of the seat 11 and is mounted linearly displaceably with respect to the latter. The sleeve 12 is prestressed to the shown first position by a first spring element 16. In this position, a ball 13 arranged in an opening 14 of the seat 11 is pressed into the interior of the seat 11 and thus in the direction of the piston 5. The piston 5 of the syringe 3 has a circumferential groove 22 in which the ball 13 engages. In this way, the piston 5 is secured with form-fit engagement in the seat 11.

As is shown in FIG. 3, the sleeve 12 can be moved away from the syringe 3, counter to the spring force of the first spring element 16, to a second position by means of an actuator 15. An inner wall of the sleeve 12 is shaped in such a way that the ball 13 can be moved out from the interior of the seat 11 when the sleeve 12 is located in the second position. In this way, the ball 13 can be released from the engagement with the circumferential groove 22, whereupon the piston 5 is freed from the coupling 8.

A ram 18 is arranged inside the seat 11 and is prestressed, by a second spring element 17, in the direction of the piston 5 or in the direction of an opening of the seat 11 into which the piston 5 can be inserted. In the embodiment shown, the two contact elements 20, 21 are arranged on this ram. In this way, they are pressed together with the ram 18 onto the chip arrangement 19 by the spring force of the second spring element 17, in particular onto the contact faces of the chip arrangement 19 of the piston 5.

When the piston 5 is released by movement of the sleeve 12 to the second position, it is pushed out of the seat 11 by the spring force of the second spring element 17 acting on the ram 18, which simplifies the removal of the piston 5 from the seat.

FIG. 4 shows a more detailed view of the chip arrangement 19 according to the embodiment of the sampling device 1 from FIGS. 1 to 3. The chip arrangement has a memory element 25, which is configured as a non-volatile memory. The memory element 25 stores data relating to the syringe 3, for example its volume, the number of executed piston strokes, etc. The memory element 25 is connected to two contact faces 23, 24, which are located on the chip arrangement. A first contact face 23 is designed as a round face. A second contact face 24 is designed as a circular surface arranged concentrically around the first round contact face 23. The first contact face 23 and the second contact face 24 are spaced apart from each other by an electrically insulating distance 27. The contact faces 23, 24 are arranged on a plate 28, which is secured on the memory element 25.

1-14. canceled

15. An actuation device for a piston of a syringe, comprising a holder for a barrel of the syringe, a coupling which is linearly movable relative to the holder and has a seat into which the piston of the syringe can be inserted, at least one securing element with which the piston can be secured releasably in the seat, and a linear drive for the coupling, wherein the coupling has at least two electrically conductive contact elements which are arranged inside the seat in order to come into contact with corresponding electrically conductive contact faces of the piston when the piston is inserted into the seat.

16. The actuation device according to claim 15, wherein an inner wall of the seat is designed as a first contact element of the at least two contact elements.

17. The actuation device according to claim 15, wherein a first contact element of the at least two contact elements is designed as a round face, and the at least one further contact element is designed as a circle concentric to the round face.

18. The actuation device according to claim 15, wherein the at least two contact elements are prestressed inside the seat, counter to a direction of insertion of the piston, by at least a first spring element.

19. The actuation device according to claim 15, wherein the at least one securing element is designed as a form-fit element, which can engage in a circumferential groove of the piston when the piston is inserted into the seat.

20. The actuation device according to claim 19, wherein the form-fit element comprises at least one ball which is placed in an opening of the seat, wherein a sleeve is arranged on the outside of the seat and is movable relative to the seat from a first position to a second position such that, in the first position, the at least one ball is pressed by the sleeve into an interior of the seat and, in the second position, the at least one ball is movable out of the interior.

21. The actuation device according to claim 15, wherein the linear drive comprises at least one spindle.

22. The actuation device according to claim 15, wherein the at least one securing element is designed in such a way that the piston can be automatically secured in the seat and released therefrom.

23. A sampling system comprising an actuation device according to claim 15 and also at least one syringe with a barrel and with a piston arranged partially inside the barrel and linearly displaceable therein, wherein a non-volatile memory element is arranged on an end of the piston not arranged inside the barrel, and wherein the memory element is connected to at least two electrically conductive contact faces which are shaped and arranged on the barrel in such a way that they can come into contact with the electrically conductive contact elements of the actuation device when the piston is inserted into the seat.

24. The sampling system according to claim 23, wherein the actuation device is connected to an electronic control system or comprises the latter, wherein the electronic control system is configured to read out data from the non-volatile memory element and/or to write data into the latter.

25. The sampling system according to claim 24, wherein the data contain at least one of the following items of information: number of piston strokes executed, size of the barrel, serial number of the syringe, production date of the syringe, total travel of the executed piston strokes, manufacturer of the syringe, data of the first executed piston stroke, size of the needle connected to the barrel.

26. The sampling system according to claim 23, wherein the form-fit element comprises at least one ball which is placed in an opening of the seat, wherein a sleeve is arranged on the outside of the seat and is movable relative to the seat from a first position to a second position such that, in the first position, the at least one ball is pressed by the sleeve into an interior of the seat and, in the second position, the at least one ball is movable out of the interior, wherein an outer circumferential surface of the piston of the syringe has a circumferential groove in which the ball engages when the sleeve is in the first position.

27. A syringe for a sampling system according to claim 23, comprising a barrel and a piston arranged partially inside the barrel and linearly displaceable therein, wherein a non-volatile memory element is arranged on an end of the piston not arranged inside the barrel, which memory element is connected to at least two electrically conductive contact faces.

28. The syringe according to claim 27, wherein a first contact face of the at least two contact faces is round, and the at least one further contact face is designed as a circle concentric to the round first contact face.
